(19) United States
(12) Patent Application Publication
(10) Pub. No.: US 2024/0212921 A1
(43) Pub. Date: Jun. 27, 2024

(54) INDUCTOR AND DC-DC CONVERTER USING THE SAME

(71) Applicant: TDK Corporation, Tokyo (JP)

(72) Inventor: Tomofumi KURODA, Tokyo (JP)

(73) Assignee: TDK Corporation, Tokyo (JP)

(21) Appl. No.: 18/396,169

(22) Filed: Dec. 26, 2023

(30) Foreign Application Priority Data
Dec. 27, 2022 (JP) 2022-209864

(51) Int. Cl. H01F 27/28; H01F 17/00; H02M 3/155

(52) U.S. Cl. CPC H01F 27/288; H01F 17/0013; H02M 3/155

(57) ABSTRACT

In the inductor, magnetic flux between the pair of coil conductors is shielded by the magnetic body interposed between the pair of coil conductors. In the inductor, since the side surface of the magnetic body protrudes outward from the juxtapositional portion of each of the coil conductors, the magnetic flux generated in the juxtapositional portion is shielded by the magnetic body. In the inductor, since the upper surface of the magnetic body is located lower than the upper surface of the connecting portion of each of the coil conductors, the magnetic body is less likely to be affected by the magnetic field generated in the connecting portion of the coil conductor. As a result, the magnetic flux distribution in the magnetic body becomes uniform, and magnetic saturation is suppressed.

### CROSS-REFERENCE TO RELATED APPLICATIONS

This application is based upon and claims the benefit of priority from Japanese Patent Application No. 2022-209864, filed on 27 Dec., 2022, the entire content of which is incorporated herein by reference.

### TECHNICAL FIELD

The present disclosure relates to an inductor and a DC-DC converter using the same.

### BACKGROUND

Japanese Patent Application Publication No. 2021-19141 (Patent Document 1) discloses an inductor having a configuration where a plurality of magnetic cores provided with a coil conductor therein and a plurality of shield portions having a higher magnetic permeability than the magnetic core are arranged, and the inductor including the plurality of coil conductors in one component. In the inductor in Patent Document 1, coupling between two of the adjacent magnetic cores is suppressed by the shield portion interposed between the two of the adjacent magnetic cores.

### SUMMARY

An inductor according to one aspect of the present disclosure includes an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction, a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors, a second coil conductor aligned with the first coil conductor in the third direction, the second coil conductor having the first conductor, the second conductor, and the third conductor, and a magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction, wherein the pair of fifth side surfaces of the magnetic body protrude outward from each of the first and second conductors of the first and second coil conductors, and the pair of fifth side surfaces of the magnetic body are close to the pair of second side surfaces of the element body, and wherein the forth side surface located on one side in the first direction of the pair of forth side surfaces of the magnetic body is located on the other side in the first direction with respect to a surface on one side in the first direction of each of the third conductors of the first and second coil conductors.

### BRIEF DESCRIPTION OF THE DRAWINGS

FIG. 1 is a schematic perspective view showing an inductor according to one embodiment.

FIG. 2 is an end view of the inductor of FIG. 1.

FIG. 3 is an exploded perspective view showing a coil conductor and a magnetic body of the inductor of FIG. 1.

FIG. 4 is a schematic perspective view showing the coil conductor of FIG. 3.

FIG. 5 is a front view of the coil conductor of FIG. 3.

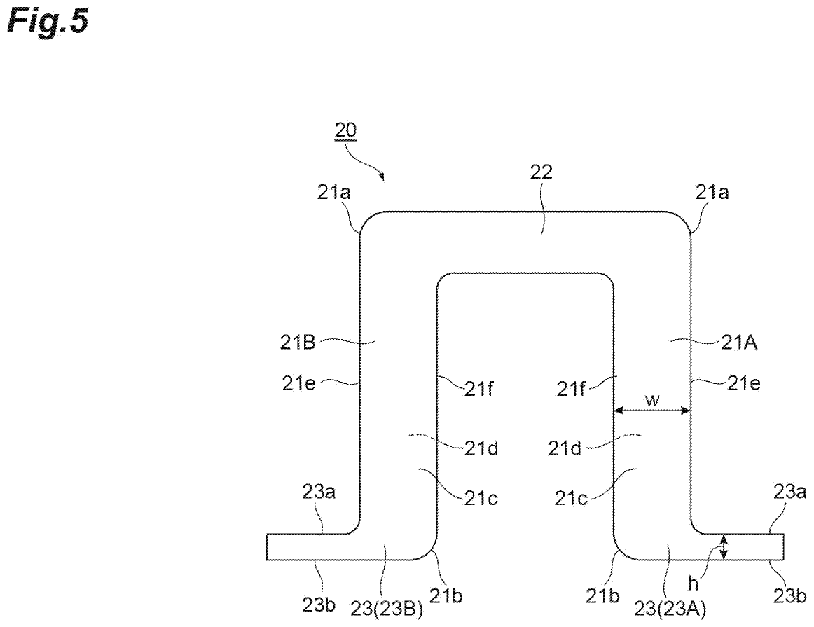

FIG. 6 is a diagram showing the configuration of the magnetic body shown in FIG. 1.

FIG. 7 is a view showing a magnetic body of a different embodiment.

FIG. 8 is a cross-sectional view of the inductor of FIG. 1 taken along line VIII-VIII.

FIG. 9 is a circuit diagram of a DC-DC converter using the inductor shown in FIG. 1.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

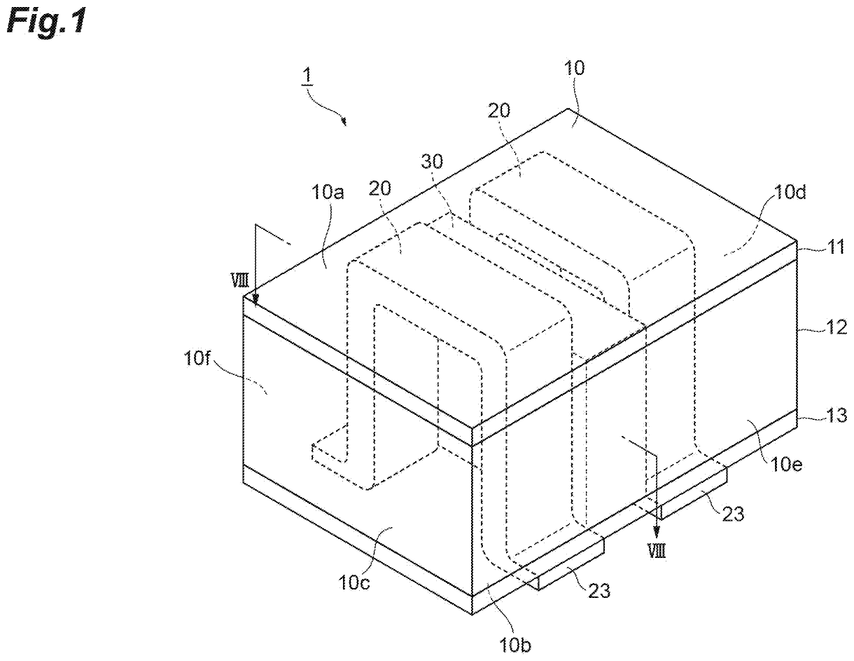

FIG. 1 shows an inductor 1 according to one embodiment. The inductor 1 is composed of an element body 10, a pair of coil conductors 20, and a magnetic body 30. That is, the inductor 1 according to the present embodiment is a multiple inductor in which two inductors are provided.

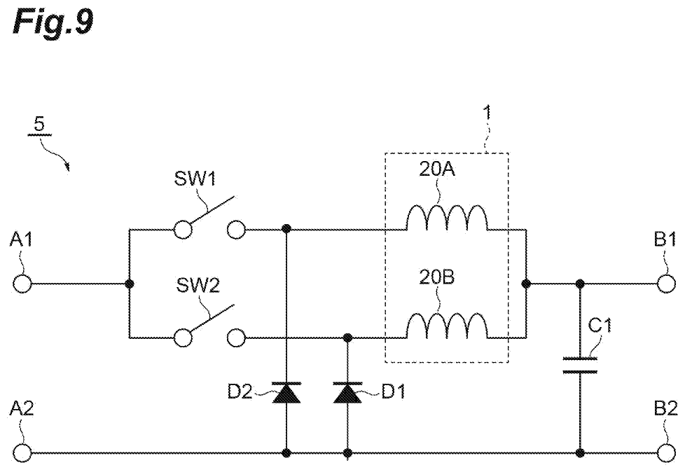

The pair of the coil conductors 20 (20A and 20B) included in the inductor 1 can be adopted for each choke coil of the circuit of the DC-DC converter 5 shown in FIG. 9. The DC-DC converter 5 is a multi-phase converter which includes a pair of conversion units including switching elements SW1 and SW2, choke coils 20A and 20B, diodes D1 and D2, and the pair of conversion units are connected in parallel. The inductor 1 can be adopted as the choke coil 20A and 20B of each conversion unit. More specifically, the DC-DC converter 5 includes a pair of input terminals A1 and A2, a pair of output terminals B1 and B2, the switching element SW1 and the choke coil 20A connected in series between the input terminal A1 and the output terminal B1 in this order, the switching element SW2 and the choke coil 20B connected in series between the input terminal A1 and the output terminal B1 in this order, and a capacitor C1 connected between the output terminals B1 and B2. A circuit of the switching element SW1 and the choke coil 20A and a circuit of the switching element SW2 and the choke coil 20B are connected in parallel between the input terminal A1 and the output terminal B1. The input terminal A2 and the output terminal B2 constitute a ground line. The diode D1 is reversely connected between the connection point of the switching element SW1 and the choke coil 20A and the ground line, and the diode D2 is reversely connected between the connection point of the switching element SW2 and the choke coil 20B and the ground line. The switching elements SW1 and SW2 are alternately turned on and off by a control circuit (not shown), whereby an output voltage obtained by dropping an input voltage is generated. By configuring the pair of the choke coil 20A and 20B in the DC-DC converter 5 with a pair of the coil conductors 20 of the inductor 1, the number of parts configuring the DC-DC converter 5 can be reduced.

The element body 10 has a substantially rectangular parallelepiped outer shape. The element body 10 has an upper surface 10a and a lower surface 10b (a pair of first surfaces) facing each other in the vertical direction which is the first direction, a pair of side surfaces 10e and 10f (a pair of second surfaces) facing each other in the second direction perpendicular to the first direction, and a pair of end surfaces 10c and 10d (a pair of third surfaces) facing each other in the third direction perpendicular to both the first and second directions. The element body 10 according to the present embodiment includes a first element body portion 11, a second element body portion 12, and a third element body portion 13. The first element body portion 11 constitutes the upper surface 10a of the element body 10, the third element body portion 13 constitutes the lower surface 10b of the element body 10, and the second element body portion 12 is interposed between the first and third element body portions 11 and 13 in the vertical direction of the element body 10.

The pair of coil conductors 20 and the magnetic body 30 are provided in the element body 10. The pair of coil conductors 20 are arranged along the facing direction of the side surfaces 10c and 10d of the element body 10, and the magnetic body 30 is interposed between the pair of coil conductors 20. In the following description, of the pair of the coil conductor 20, the coil conductor 20 located on the side surface 10c side is referred to as a first coil conductor 20A, and the coil conductor 20 located on a side surface 10d side is referred to as a second coil conductor 20B, as necessary.

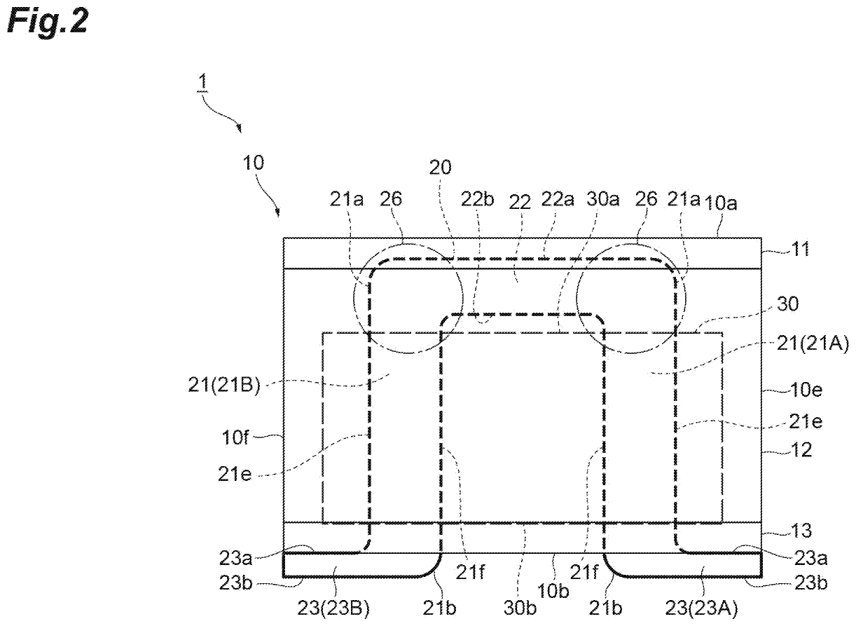

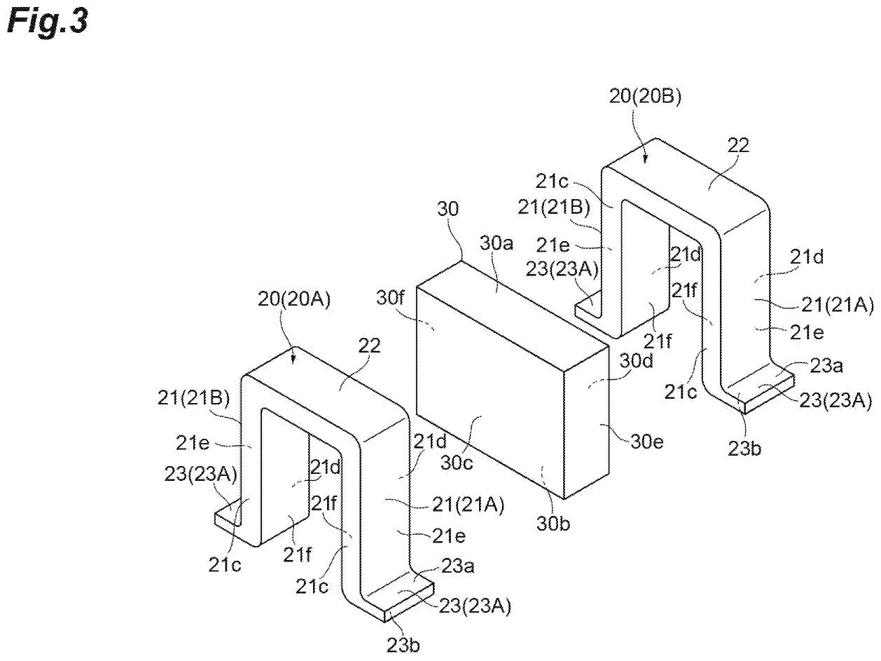

As shown in FIGS. 2 and 3, each of the pair of coil conductors 20 has a configuration in which one elongated strip-shaped conductor is waved like a substantially rectangular wave. Each of the coil conductors 20 can be formed, for example, by bending a single elongated strip conductor. More specifically, each of the coil conductors 20 includes a pair of a juxtapositional portions 21, a connecting portion 22, and a pair of terminal portions 23. Each of the coil conductors 20 is made of a metal selected from Cu, Ag, Au, Al, and Ni, and is made of Cu in the present embodiment. The surface of each of the coil conductors 20 may be covered with an insulating coating (not shown). For example, each of the juxtapositional portions 21 and the connecting portion 22 may be covered with an insulating coating.

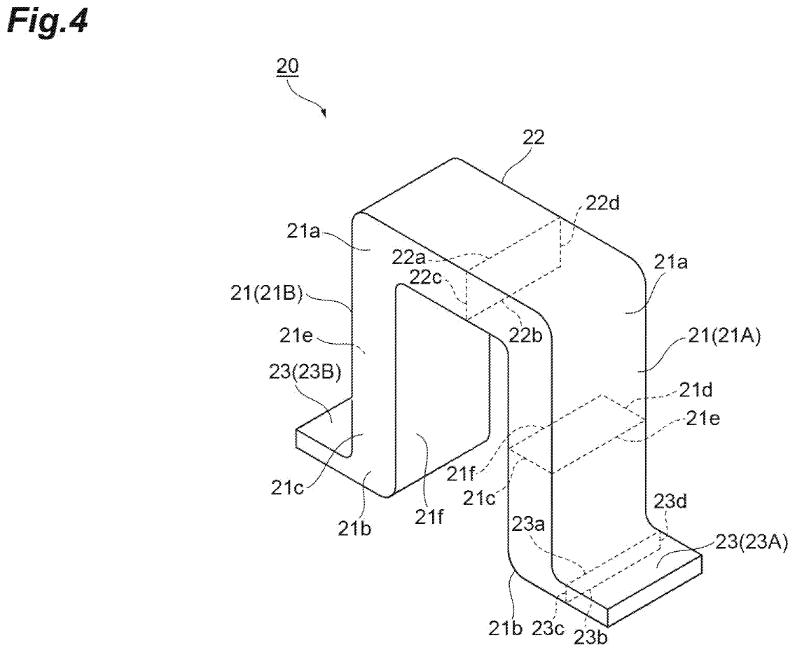

The pair of the juxtapositional portions 21 are composed of a first juxtapositional portion 21A (first conductor) and a second juxtapositional portion 21B (second conductor). The first juxtapositional portion 21A and the second juxtapositional portion 21B have the same length and extend parallel to each other. In a state where the coil conductors 20 are attached to the element body 10 as shown in FIG. 1, the pair of the juxtapositional portions 21 extends in the thickness direction of the element body 10 (i.e., a first direction in which the upper surface 10a and the lower surface 10b face each other). Each of the first juxtapositional portion 21A and the second juxtapositional portion 21B have an upper end portion 21a (first end portion) located on the upper surface 10a side, and the upper end portion 21a are aligned in the facing direction of the pair of the side surfaces 10e and 10f. Similarly, the first juxtapositional portion 21A and the second juxtapositional portion 21B have a lower end portion 21b (second end portion) located on the lower surface 10b side, and the lower end portions 21b are aligned in the facing direction of the pair of side surface 10e and 10f. As shown in FIG. 4, each of the pair of juxtapositional portions 21 has a rectangular cross section in a cross section perpendicular to its extending direction, has side surfaces 21c and 21d parallel to the end surfaces 10c and 10d of the element body 10, and has an outer side surface 21e and an inner side surface 21f parallel to the side surfaces 10e and 10f of the element body 10. The side surface 21c of the juxtapositional portion 21 faces toward the end surface 10c of the element body 10 and the side surface 21d faces toward the end surface 10d of the element body 10. Each of the outer side surfaces 21e of the juxtapositional portions 21 faces outward. Each of the inner side surfaces 21f faces inward and the inner side surfaces 21f face each other.

The connecting portion 22 (third conductor) is a portion connecting the upper end portions 21a of the juxtapositional portions 21, and extends in a straight line in the facing direction of the side surfaces 10e and 10f of the element body 10. As shown in FIG. 4, the connecting portion 22 has a rectangular cross section in a cross section perpendicular to its extending direction. The connecting portion 22 has an upper surface 22a and a lower surface 22b parallel to the upper surface 10a and the lower surface 10b of the element body 10. The connecting portion 22 has side surfaces 22c and 22d parallel to the end surfaces 10c and 10d of the element body 10. The side surface 22c of the connecting portion 22 faces toward the end surface 10c of the element body 10 and the side surface 22d faces toward the end surface 10d of the element body 10. A connection part 26 of the juxtapositional portion 21 and the connecting portion 22 (see FIG. 2) is curved at right angle, and outer and inner surfaces of the connection part 26 constitute curved surfaces.

A pair of terminal portions 23 (fourth conductors) are ends of the coil conductor 20 and extend away from each the lower end portions 21b of the juxtapositional portions 21. In a state where the coil conductors 20 are attached to the element body 10 as shown in FIG. 2, the pair of the terminal portions 23 are exposed on the lower surface 10b of the element body 10 and extends in the facing direction of the side surfaces 10e and 10f. Specifically, as shown in FIG. 2, of the pair of the terminal portion 23, a first terminal portion 23A extends toward the side surface 10e and a second terminal portion 23B extends toward the side surface 10f. As shown in FIG. 4, each of the terminal portions 23 has a rectangular cross section in a cross section perpendicular to its extending direction. Each of the terminal portions 23 has an upper surface 23a and a lower surface 23b parallel to the upper surface 10a and the lower surface 10b of the element body 10. Each of the terminal portions 23 has side surfaces 23c and 23d parallel to the end surfaces 10c and 10d of the element body 10. The side surface 23c of the terminal portion 23 faces toward the end surface 10c of the element body 10 and the side surface 23d faces toward the end surface 10d of the element body 10. In the present embodiment, the height h (i.e., the dimension in the first direction) of each of the terminal portions 23 is shorter than the width W (i.e., the dimension in the second direction) of each of the juxtapositional portions 21. The pair of the terminal portions 23 function as terminal of the inductor 1, and can be electrically connected to terminals on the circuit board on which the inductor 1 is surface-mounted. In the present embodiment, the pair of the terminal portions 23 end on the lower surface 10b, but may be extended to extend along the side surfaces 10e and 10f as necessary. Further, the pair of terminal portions 23 may extend along the facing direction of the side surfaces 10e and 10f so as to approach each other as long as they are not in contact with each other. The coil conductors 20 may be configured without the pair of terminal portions 23, in which case the lower end portions 21b of the juxtapositional portions 21 can be electrically connected to terminals on the circuit board on which the inductor 1 is surface-mounted.

The magnetic body 30 has a rectangular plate-shaped outer shape and extends in parallel to a plane including the first direction and the second direction. The magnetic body 30 has an upper surface 30a and a lower surface 30b (a pair of forth side surfaces) facing each other in the first direction, a pair of side surfaces 30e and 30f (a pair of fifth side surfaces) facing each other in the second direction, and a pair of end surfaces 30c and 30d (a pair of sixth side surfaces) facing each other in the third direction. The upper surface 30a and the lower surface 30b of the magnetic body 30 are parallel to the upper surface 10a and the lower surface 10b of the element body 10, respectively.

The end surfaces 30c and 30d of the magnetic body 30 are parallel to the end surfaces 10c and 10d of the element body 10, respectively. The side surfaces 30e and 30f of the magnetic body 30 are parallel to the side surfaces 10e and 10f of the element body 10, respectively. As shown in FIG. 2, the upper surface 30a of the magnetic body 30 is located below the upper surface 22a of the connecting portion 22 of each of the coil conductors 20. The lower surface 30b of the magnetic body 30 is not exposed to the lower surface 10b of the element body 10, and the third element body portion 13 is interposed between the magnetic body 30 and the lower surface 10b in the vertical direction. The height position of the upper surface 30a of the magnetic body 30 may be lower than the height position of the lower surface 22b of the connecting portion 22 of each of the coil conductors 20, or may be between the height positions of the upper surface 22a and the lower surface 22b of the connecting portion 22 of each of the coil conductors 20.

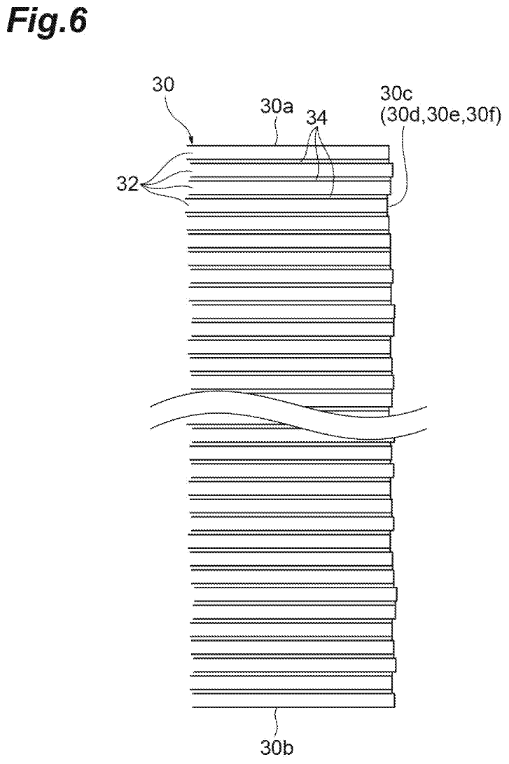

The magnetic body 30 is configured to have a relatively high magnetic permeability, and may be designed to have a magnetic permeability higher than that of magnetic powder-containing resin constituting the second element body portion 12 and the third element body portion 13, which will be described later. As shown in FIG. 6, the magnetic body 30 according to the present embodiment includes a plurality of magnetic ribbons 32 (more specifically, ribbons made of metallic soft magnetic material) stacked in the vertical direction of the element body 10 (that is, the first direction), and has a stacked structure in which a plurality of the magnetic ribbons 32 and a plurality of adhesive layer 34 are alternately arranged. The upper surface 30a and the lower surface 30b of the magnetic body 30 may be composed of the magnetic ribbon 32 or the adhesive layer 34. The number of the magnetic ribbons 32 constituting the magnetic body 30 is, for example, 120. The magnetic ribbon 32 may be made of, for example, an amorphous alloy, a microcrystalline alloy, a permalloy, a magnetic alloy such as an alloy having a nanohetero structure. The amorphous alloy material is, for example, a Fe-based amorphous soft magnetic material, a Co-based amorphous soft magnetic material. The microcrystalline alloy is, for example, a Fe-based nanocrystalline soft magnetic material. The nanohetero structure refers to a structure in which microcrystals exist in an amorphous. The surface of the magnetic body 30 may be covered with an insulating coating (not shown) as necessary.

Since the magnetic body 30 according to the present embodiment is configured to include the plurality of magnetic ribbons 32, the end surfaces 30c and 30d and the side surfaces 30e and 30f are unlikely to be even (smooth or flat), and some degree of unevenness is generated over the entire length in the vertical direction. As a result, the magnetic body 30 has rougher surfaces in the end surfaces 30c and 30d, the side surfaces 30e and 30f than in the upper surface 30a and the lower surface 30b. The rough surfaces improve adhesion to the element body 10 in contact with the magnetic body 30.

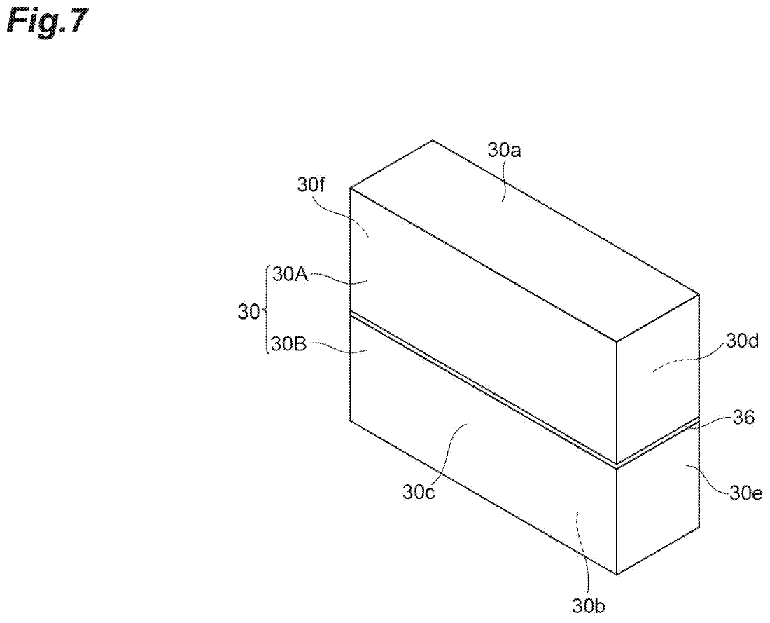

The magnetic body 30 may be composed of a plurality of blocks (magnetic blocks). For example, as shown in FIG. 7, the magnetic body 30 may be composed of two magnetic body blocks 30A and 30B that stack in the vertical direction. Each of the magnetic body blocks 30A and 30B has a laminated structure in which the plurality of magnetic ribbons 32 and the plurality of adhesive layers 34 shown in FIG. 6 are alternately arranged. The magnetic body blocks 30A and 30B are adhered by an adhesive layer 36. The material of the adhesive layer 36 may be the same as or different from the material of the adhesive layer 34 included in the magnetic body blocks 30A and 30B. The magnetic body 30 is not limited to a laminated structure, and may be a single-layer structure, for example, a single-layer ferrite block.

Next, element body portions 11 to 13 constituting the element body 10 will be described in more detail.

As shown in FIGS. 1 and 2, the element body 10 has a structure in which the first element body portion 11, the second element body portion 12, and the third element body portion 13 are arranged in order from the top. The first element body portion 11 (second element body portion) is made of a non-magnetic resin-containing material, for example, a liquid crystal polymer. The second element body portion 12 (first element body portion) and the third element body portion 13 are both made of material containing magnetic material, for example, magnetic powder-containing resin (in particular, thermosetting resin containing soft magnetic metal powder). The soft magnetic metal powder is, for example, Fe, Fe—Si alloy, a permalloy, a sendust, amorphous, microcrystalline alloy, or combination thereof. As the thermosetting resin, for example, an epoxy resin can be used. The materials of the second element body portion 12 and the third element body portion 13 may be the same or different. The first element body portion 11 may include magnetic material, and may be the same material as the material of the second element body portion 12 or the material of the third element body portion 13.

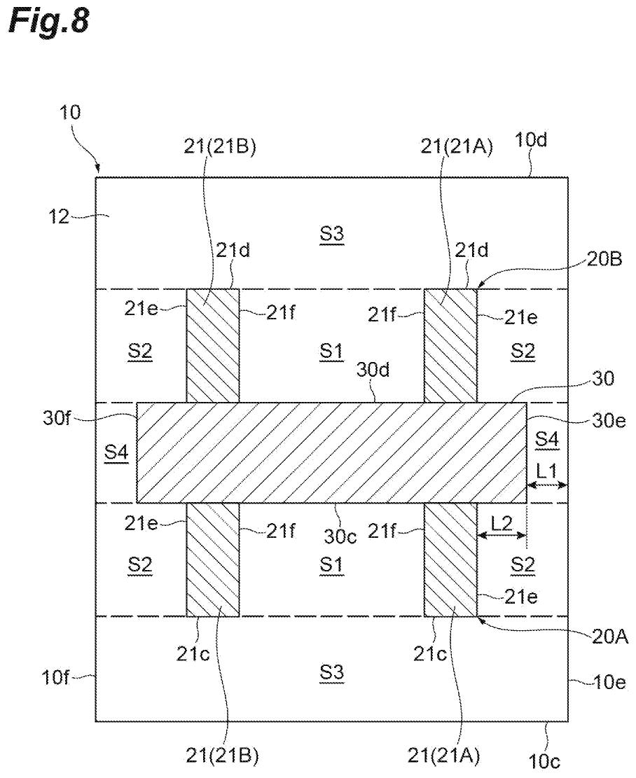

The first element body portion 11 composes the upper surface 10a of the element body 10 and has a generally flat profile extending parallel to the upper surface 10a. The third element body portion 13 (fifth portion) composes the lower surface 10b of the element body 10 and has a generally flat profile extending parallel to the lower surface 10b. The second element body portion 12 is sandwiched vertically between the first element body portion 11 and the third element body portion 13 and extends parallel to the upper surface 10a and the lower surfaces 10b of the element body 10. As shown in the cross-sectional view of FIG. 8, more specifically, the second element body portion 12 has four areas S1 to S4. Of the four areas, the first area S1 is an area between the first juxtapositional portion 21A and the second juxtapositional portion 21B in the second direction, the second area S2 is an area between the juxtapositional portion 21 and the side surface 10e and 10f in the second direction, the third area S3 is an area closer to the end surfaces 10c and 10d than the coil conductor 20, and the forth area S4 is an area between the magnetic body 30 and the side surfaces 10e and 10f.

The first area S1 is in contact with the inner side surface 21f of each of the juxtapositional portions 21A and 21B of the coil conductor 20 and with the end surfaces 30c and 30d of the magnetic body 30. The second area S2 is in contact with the outer side surface 21e of each of the juxtapositional portions 21A and 21B of the coil conductor 20, and with the end surfaces 30c and 30d of the magnetic body 30, and constitutes a part of the side surfaces 10e and 10f of the element body 10. The third area S3 is in contact with the side surfaces 21c and 21d of each of the juxtapositional portions 21A and 21B of the coil conductor 20, and constitutes a part of the end surfaces 10c and 10d of the element body 10. The forth area S4 is in contact with the side surface 30e and 30f of the magnetic body 30 and constitutes a part of the side surfaces 10e and 10f of the element body 10.

As shown in FIG. 8, the side surfaces 30e and 30f of the magnetic body 30 protrude outward from the juxtapositional portions 21A and 21B of the coil conductors 20A and 20B, respectively, and are approaching the side surface 10e and 10f of the element body 10. In the present embodiment, the side surface 30e and 30f of the magnetic body 30 protrude from the juxtapositional portions 21A and 21B of the coil conductors 20A and 20B, respectively, by length L2. The length L1 of the forth area S4 in the second direction is shorter than the length L2. Thereby, the leakage magnetic flux at the side surfaces 10e and 10f of the element body 10 can be suppressed while increasing the inductance in the inductor 1.

In the present embodiment, as shown in FIG. 8, the end surfaces 30c and 30d of the magnetic body 30 are in direct contact in the third direction with the juxtapositional portions 21A and 21B of the coil conductors 20A and 20B, respectively. The distances between the juxtapositional portions 21A and 21B of the coil conductors 20A and the 20B and the magnetic body 30 are shorter than the length of the third area S3 in the third direction and shorter than the length of the magnetic body 30 in the third direction. The end surfaces 30c and 30d of the magnetic body 30 may be arranged so as to be apart from the juxtapositional portions 21A and 21B of the coil conductors 20A and 20B in the third direction by predetermined distance. In this case, the gap between the magnetic body 30 and the juxtapositional portions 21A and 21B can be filled with the material constituting the second element body portion 12. The material constituting the second element body portion 12 may completely fill the gap between the magnetic body 30 and the juxtapositional portions 21A and 21B, or may partially fill the gap between the magnetic body 30 and the juxtapositional portions 21A and 21B.

As shown in FIGS. 1 and 2, the first element body portion 11 integrally covers, from the upper surface 10a side of the element body 10, the upper surface 22a of the connecting portion 22 of each of the first coil conductor 20A and the second coil conductor 20B, the upper surface 30a of the magnetic body 30, and the upper surface of each of the second portion S2, the third portion S3, and the fourth portion S4 of the second element body portion 12. The height position of the interface between the first element body portion 11 and the second element body portion 12 can be appropriately set. In the present embodiment, the interface between the first element body portion 11 and the second element body portion 12 is located between the upper surface 22a and the lower surface 22b of the connecting portion 22, and the second element body portion 12 is interposed at least partially between the first element body portion 11 and the connection part 26 of the juxtapositional portion 21 and the connecting portion 22. In this case, the lower surface 22b of the connecting portion 22 is entirely covered with the magnetic powder-containing resins constituting the second element body portion 12. In the coil conductors 20A and 20B, the connection part 26 between the juxtapositional portion 21 and the connecting portion 22 may be curved. Since the magnetic field generated in the curved connection part 26 of the coil conductors 20A and 20B has small vertical components, inductance can be increased without increasing eddy-current loss. The third element body portion 13 integrally covers the lower surface 30b of the magnetic body 30 and the lower surfaces of the first portion S1, the second portion S2, the third portion S3, and the fourth portion S4 of the second element body portion 12 from the lower surface 10b side of the element body 10. The height position of the interface between the second element body portion 12 and the third element body portion 13 can also be appropriately set.

In the above-described inductor 1, when a voltage is applied to each of the coil conductors 20 via each of the terminal portions 23, a current flows through each of the coil conductors 20. At this time, a magnetic flux is generated mainly in the juxtapositional portions 21 and the connecting portion 22 of each of the coil conductors 20. At this time, the magnetic flux between the coil conductors 20A and 20B is shielded by the magnetic body 30 interposed between the coil conductors 20A and 20B. In the inductor 1, since the side surfaces 30e and 30f of the magnetic body 30 protrude outward from the juxtapositional portions 21 of each of the coil conductors 20, the magnetic flux generated in the juxtapositional portions 21 is shielded by the magnetic body 30. In the inductor 1, since the upper surface 30a of the magnetic body 30 is located below the upper surfaces 22a of the connecting portions 22 of each of the coil conductors 20, the magnetic body 30 is less likely to be affected by the magnetic field generated in the connecting portion 22 of each of the coil conductors 20. Therefore, the magnetic flux distribution in the magnetic body 30 becomes uniform, and suppression of magnetic saturation (that is, improvement of saturation characteristics) can be realized.

In the inductor according to the related art, when magnetic saturation occurs, inductor characteristics may be deteriorated. The inventors have studied magnetic saturation of the inductor and newly found a technique capable of suppressing magnetic saturation.

In the inductor 1, magnetic saturation is suppressed while coupling between coil conductors is suppressed.

The technology according to the present disclosure includes, but is not limited to, the following configuration examples.

An inductor according to one aspect of the present disclosure includes an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction, a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors, a second coil conductor aligned with the first coil conductor in the third direction, the second coil conductor having the first conductor, the second conductor, and the third conductor, and a magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction, wherein the pair of fifth side surfaces of the magnetic body protrude outward from each of the first and second conductors of the first and second coil conductors, and the pair of fifth side surfaces of the magnetic body are close to the pair of second side surfaces of the element body, and wherein the forth side surface located on one side in the first direction of the pair of forth side surfaces of the magnetic body is located on the other side in the first direction with respect to a surface on one side in the first direction of each of the third conductors of the first and second coil conductors.

In the inductor, the magnetic flux between the first and second coil conductors is shielded by the magnetic body interposed between the first and second coil conductors. Since the side surface of the magnetic body protrudes outward from the juxtapositional portion of each of the coil conductor, the magnetic flux generated in the first and second conductors is shielded by the magnetic body. In addition, since the upper surface of the magnetic body is located lower than the upper surface of the third conductor of the coil conductor, the magnetic body is less likely to be affected by a magnetic field generated in the third conductor of each of the coil conductors. Thus, magnetic flux distribution in the magnetic body becomes uniform, and magnetic saturation is suppressed (that is, saturation characteristics are improved).

In an inductor according to another aspect, the first element body portion of the element body includes a first portion located between the first and second conductors of each of the first and second coil conductors, a second portion located outside the first and second conductors of each of the first and second coil conductors in the second direction, and a third portion connecting the first and second portions outside each of the first and second conductors in the third direction. In this case, magnetic circuits through the first element body portion and the magnetic body can be continuously formed around the first and second conductor of the first and second coil conductor, respectively, and high inductance can be obtained.

In an inductor according to another aspect, the first element body portion of the element body further includes a forth portion located outside the magnetic body in the second direction. In an inductor according to another aspect, protruding length of each of the side surfaces of the magnetic body from the first and second conductors of the first and second coil conductors is longer than length of the forth portion in the second direction. In this case, the leakage magnetic flux at the side surface of the element body can be suppressed while increasing the inductance.

In an inductor according to another aspect, the first element body portion of the element body further includes a fifth portion integrally covering the lower surface, and the lower surfaces of the first portions, the second portions, and the third portions of the element body portion. In this case, the leakage magnetic flux at the lower surface of the element body can be suppressed while increasing the inductance.

In an inductor according to another aspect, the element body further includes a second element body portion made of a resin-containing material, the second element body portion integrally covering a surface on the one side in the first direction of the third conductor of each of the first and second coil conductors, a surface on the one side in the first direction of the magnetic body, and surfaces on the one side in the first direction of the second and third portions of the first element body portion. In this case, the second element body portion made of a resin-containing material can reduce magnetic flux components in the first direction among magnetic fluxes generated in the third conductor, and can further reduce the occurrence of eddy-current loss due to the magnetic flux components in the first direction.

In the inductor according to another aspect, distances between the first and second conductors of each of the first and second coil conductors and the magnetic body are shorter than length of the third portion of the first element body portion in the third direction and shorter than lengths of the magnetic body in the third direction. In this case, since each of the first and second coil conductors are close to the magnetic body are approaching and close to the magnetic body, the magnetic body having a relatively high magnetic permeability is easily excited by the current flowing through each of the first and second coil conductors, and a high inductance can be obtained.

In the inductor according to another embodiment, a gap between the first and second conductors of each of the first and second coil conductors and the magnetic body is filled with the magnetic-powder-containing resin constituting the first element body portion. When the gap between the coil conductor and the magnetic body is filled with the magnetic powder-containing resin, high inductance can be obtained.

In the inductor according to another aspect, the first and second conductors of each of the first and second coil conductors are in direct contact with the magnetic body. In this case, since the magnetic body is in contact with the first and second coil conductors, distances between the magnetic body and the coil conductor are stable, and a stable inductance value can be obtained.

According to another aspect of the present disclosure, the magnetic body is formed by stacking in the first direction a plurality of magnetic ribbons made of amorphous ribbon or nanocrystalline ribbon via an insulation layer. By using such a material having high magnetic permeability, saturation magnetization is increased, and excellent DC superposition characteristics can be realized.

According to another aspect of the present disclosure, the magnetic body includes a plurality of magnetic blocks, each of the magnetic blocks is formed by stacking in the first direction a plurality of magnetic ribbons made of amorphous ribbon or nanocrystalline ribbon via an insulation layer. The plurality of magnetic blocks are stacking in the first direction. By using such a material having high magnetic permeability, saturation magnetization is increased, and excellent DC superposition characteristics can be realized. In addition, as the number of laminations of the magnetic body increases, the positional shift due to the lamination is more likely to occur. Therefore, by dividing the magnetic body into a plurality of blocks and stacking the blocks, it is possible to reduce the above positional shift and improve dimensional accuracy.

In an inductor according to another aspect, each of the pair of fifth side surfaces and the pair of sixth side surfaces of the magnetic body is a concave-convex surface, and the concave-convex surface is in direct contact with the first element body portion of the element body. When the magnetic powder-containing resin of the first element body portion enter the concave-convex, the gaps that cause a decrease in inductance are filled, and high inductance can be obtained.

A DC-DC converter according to an embodiment of the present disclosure includes the above inductor. Accordingly, it is possible to obtain a DC-DC converter including an inductor in which magnetic saturation is suppressed while suppressing coupling between the coil conductors.

Note that the present disclosure is not limited to the above-described embodiment, and various modifications can be made without departing from the scope of the present disclosure. For example, three or more coil conductors may be included in the inductor. A plurality of magnetic materials may be contained in the magnetic body.

1. An inductor comprising:
an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction;
a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors;
a second coil conductor aligned with the first coil conductor in the third direction, the second coil conductor having the first conductor, the second conductor, and the third conductor; and
a magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction;
wherein the pair of fifth side surfaces of the magnetic body protrude outward from each of the first and second conductors of the first and second coil conductors, and the pair of fifth side surfaces of the magnetic body are close to the pair of second side surfaces of the element body, and
wherein the forth side surface located on one side in the first direction of the pair of forth side surfaces of the magnetic body is located on the other side in the first direction with respect to a surface on one side in the first direction of each of the third conductors of the first and second coil conductors.

2. The inductor according to claim 1, wherein the first element body portion of the element body includes a first portion located between the first and second conductors of each of the first and second coil conductors, a second portion located outside the first and second conductors of each of the first and second coil conductors in the second direction, and a third portion connecting the first and second portions outside each of the first and second conductors in the third direction.

3. The inductor according to claim 2, wherein the first element body portion of the element body further includes a forth portion located outside the magnetic body in the second direction.

4. The inductor according to claim 3, wherein protruding length of each of the pair of fifth side surfaces of the magnetic body from the first and second conductors of the first and second coil conductors is longer than length of the forth portion in the second direction.

5. The inductor according to claim 2, wherein the first element body portion of the element body further includes a fifth portion integrally covering the forth side surface located on the other side in the first direction of the pair of forth side surfaces of the magnetic body, and a surface on the other side in the first direction of the first portions, the second portions, and the third portions of the element body portion.

6. The inductor according to claim 2, wherein the element body further includes a second element body portion made of a resin-containing material, the second element body portion integrally covering a surface on the one side in the first direction of the third conductor of each of the first and second coil conductors, a surface on the one side in the first direction of the magnetic body, and surfaces on the one side in the first direction of the second and third portions of the first element body portion.

7. The inductor according to claim 1, wherein distances between the first and second conductors of each of the first and second coil conductors and the magnetic body are shorter than length of the third portion of the first element body portion in the third direction and shorter than lengths of the magnetic body in the third direction.

8. The inductor according to claim 1, wherein a gap between the first and second conductors of each of the first and second coil conductors and the magnetic body is filled with a material constituting the first element body portion.

9. The inductor according to claim 1, wherein the first and second conductors of each of the first and second coil conductors are in direct contact with the magnetic body.

10. The inductor according to claim 1, wherein the magnetic body is formed by stacking in the first direction a plurality of magnetic ribbons made of amorphous ribbon or nanocrystalline ribbon via an insulation layer.

11. The inductor according to claim 1, wherein the magnetic body includes a plurality of magnetic blocks, each of the magnetic blocks is formed by stacking in the first direction a plurality of magnetic ribbons made of amorphous ribbon or nanocrystalline ribbon via an insulation layer.

12. The inductor according to claim 11, wherein the plurality of magnetic blocks are stacked in the first direction.

13. The inductor according to claim 1, wherein each of the pair of fifth side surfaces and the pair of sixth side surfaces of the magnetic body is a concave-convex surface, and the concave-convex surface is in direct contact with the first element body portion of the element body.

14. A DC-DC converter comprising the inductor according to claim 1.
